(19) United States
(12) Patent Application Publication
(10) Pub. No.: US 2026/0113334 A1
(43) Pub. Date: Apr. 23, 2026

(54) MANAGEMENT OF PERMISSIONSS ON PROJECT BY PROJECT BASIS

(71) Applicant: Kyndryl, Inc., New York, NY (US)

(72) Inventor: Cesar Augusto Rodriguez Bravo, Alajuela (CR)

(21) Appl. No.: 18/921,705

(22) Filed: Oct. 21, 2024

(51) Int. Cl. H04L 9/40; H04L 67/10

(52) U.S. Cl. CPC H04L 63/108; H04L 67/10

(57) ABSTRACT

Aspect of the disclosure include a computer-implemented method including: scanning, by a computing device, one or more sources on a predetermined schedule to obtain project information; extracting, by the computing device, project data from the project information, the project data including at least a user assigned to a task and a resource required to complete the task; determining, by the computing device, that the user has permission to access the resource associated with the task; and providing, by the computing device, the permission to the user to access the resource for a predetermined time period such that the user can gain access to the resource for the predetermined time period to work on the task.

### BACKGROUND

Aspects of the present invention relate generally to management of user accounts and, more particularly, a system, method and computer program product which enables automated and secure management of permissions on a project-by-project basis.

The principle of least privilege (PoLP) policies is a cybersecurity strategy that limits user access to a minimum level of permissions needed to perform their jobs. Similarly, Identify Access Management (IAM) systems are a framework of policies and technologies to ensure that the right users have the appropriate access to technology resources. The goal of PoLP and IAM is to reduce the risk of damage if credentials are compromised. For example, PoLP dictates that users receive only essential permissions for their tasks. In this way, a user account designed for a task, e.g., database record retrieval or updating code lines, can obtain access to only such systems and be denied access to other system types, e.g., administrative rights to access financial data.

### SUMMARY

In a first aspect of the invention, there is a computer-implemented method including: scanning, by a computing device, one or more sources on a predetermined schedule to obtain project information; extracting, by the computing device, project data from the project information, the project data including at least a user assigned to a task and a resource required to complete the task; determining, by the computing device, that the user has permission to access the resource associated with the task; and providing, by the computing device, the permission to the user to access the resource for a predetermined time period such that the user can gain access to the resource for the predetermined time period to work on the task.

In another aspect of the invention, there is a computer program product including one or more computer readable storage media having program instructions collectively stored on the one or more computer readable storage media. The program instructions are executable to: scan one or more project artifacts on a predetermined schedule to obtain project information; extract the project information to obtain identification information of a resource and contact information of a user; determine the user has permission to access the resource to complete a task that is scanned from the one or more project artifacts; and provide the user with the permission to access the resource using the contact information and including the identification information of the resource

In another aspect of the invention, there is system including a processor, a computer readable memory, one or more computer readable storage media, and program instructions collectively stored on the one or more computer readable storage media. The program instructions are executable to: scan project information from one or more sources based on a predetermined schedule; extract from the project information user information of a user assigned to a task and a resource location of a resource required to complete the task; determine that the user assigned to the task should have permission to access the resource; and provide instructions to a management system to send a permission to the user to access the resource.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a Gant chart in accordance with aspects of the invention.

FIG. 6 shows extraction of information in accordance with aspects of the invention.

FIG. 7 shows a flowchart of an exemplary method in accordance with aspects of the invention.

### DETAILED DESCRIPTION

Aspects of the present invention relate generally to management of user accounts and, more particularly, a system, method and related computer program product which enables automated and secure management of permissions on a project-by-project basis. In more specific aspects of the invention, the system, method and related computer program product are configured to manage user accounts by enabling an automated and secure implementation of a least privilege policy on projectized organizations, e.g., organizations that provide access to resources on a project-by-project basis. For example, the system, method and related computer program product provide a technical solution comprising a tool to automate Identity and Access Management (IAM) on a project level, providing access management to a plurality of resources, e.g., specific data, computing infrastructure (e.g., servers) and/or applications based on current assignments of the users.

As should be understood by those of skill in the art, PoLP policies provide information security by maintaining and managing user access to only specific resources on a need be basis in order to complete a task. The resources may include servers, computers or other infrastructure, in addition to specific data, documents, applications, etc. Organizations leverage PoLP as a mechanism to prevent a plurality of different threats; however, implementing PoLP policies is not an easy task and many organizations struggle and fail to implement such policies. For example, current methods of implementing PoLP policies require an administrator to manually provide and restrict access to users for certain time periods to complete certain tasks. For the PoLP policy to be rescinded, the user must notify the administrator that the project has been completed at which time the administrator will need to remove permissions for the user. Accordingly, it is not uncommon that policies remain intact even when the project has been completed. This is due to the user not providing the proper notification or the administrator not rescinding the permissions after such notification is given. This makes Identity and Access Management (IAM) less robust. Aspects of the present invention, though, provide a technical feature (e.g., technical solution) to this technical problem with a practical application of providing automated tools enabling efficient access management to resources on a project level such that when the user has completed their specific task or project, permissions will automatically be rescinded and when tasks are not completed, permissions will be automatically granted.

By way of example, the technical solution includes a system, method and related computer program product which enables an automated and secure implementation of PoLP policies integrated, for example, with IAM processes on a project by project basis, based on each task and the users or groups required to execute such tasks. This will provide security and automation to the IAM process of projectized organizations, which translates into cost and risk reduction. This can be done by gathering data from several project artifacts. As should be understood by those of skill in the art, project artifacts are documents, outputs, and other deliverables that define and support a project's process. For example, such documents may include, e.g., Gant charts, project charters, project plans, project stakeholder lists, work breakdown structure (WBS), etc.

In implementation, the system, method and related computer program product will scan the activities for each day (e.g., at 00:00), and use an extraction engine (module) to gather the relevant data from the scanned activities including, for example, tasks for the day, resources needed to complete the tasks, and users assigned to the tasks. The system, method and related computer program product will automatically execute a request to the IAM or other management-type system to allow access (e.g., permissions) to assigned users or groups to the resources for the duration of the task. The system, method and related computer program product can connect to the IAM or other management-type system (which may also be integrated into the present system) using an API, and send a request to a given group through a ticketing system. The access will be dynamic, therefore if a given task is extended by a project manager, for example, the system, method and related computer program product will automatically adjust the permissions accordingly. Once the task is marked as completed on the project plan, any permissions to access a resource for the project will be rescinded, ensuring compliance with the PoLP. Similarly, as the project plan is updated, e.g., with different tasks, timelines to complete tasks, or user access permission, the system, method and related computer program product can update its permissions based on the updated project plan, during the next scan cycle. In this way, the user does not have to notify an administrator to take any action to ensure compliance with the PoLP, nor does the administrator have to rescind such permissions after notification by the user or manually provide permissions after review of required daily tasks.

It should be understood that, to the extent implementations of the invention collect, store, or employ personal information provided by, or obtained from, individuals (for example, user identification) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

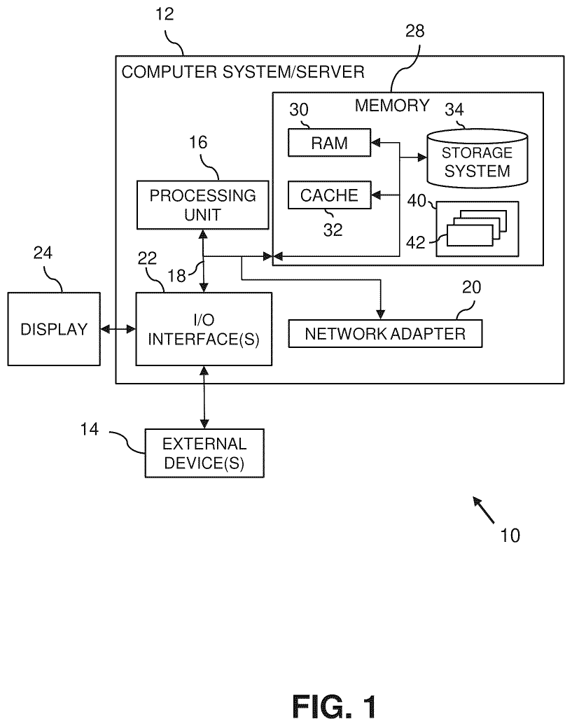

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

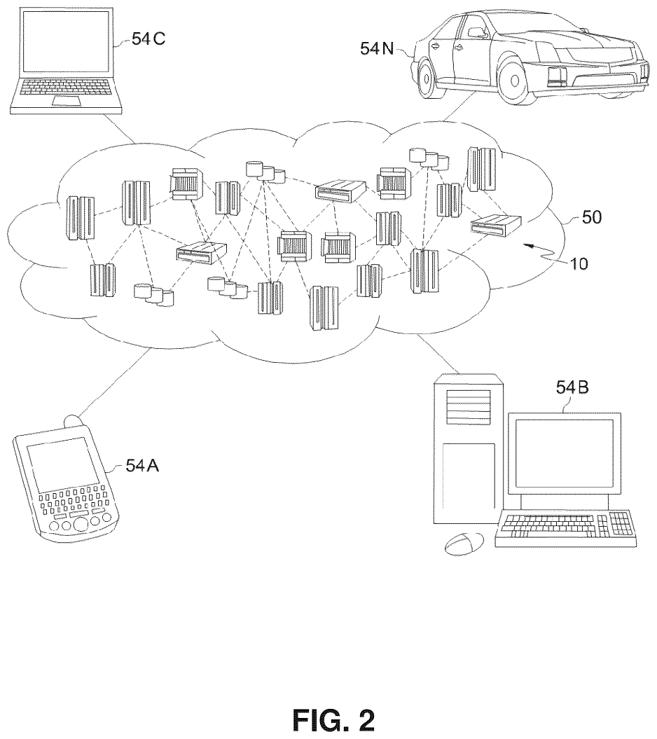

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

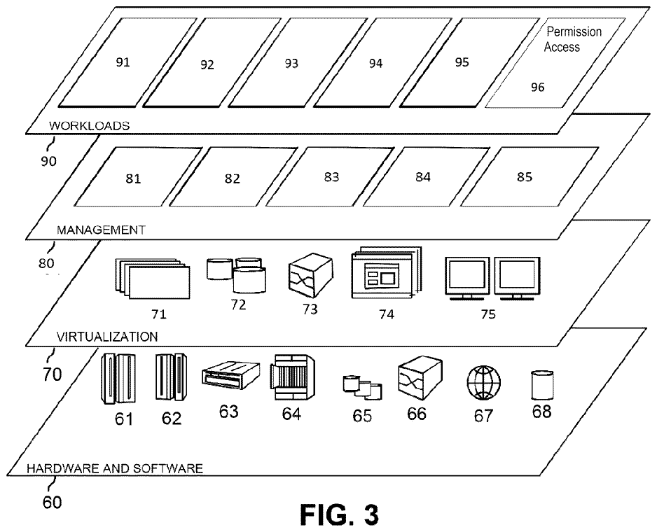

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and permission access 96.

Implementations of the invention may include a computer system/server 12 of FIG. 1 in which one or more of the program modules 42 are configured to perform (or cause the computer system/server 12 to perform) one of more functions of the permission access 96 of FIG. 3. For example, the one or more of the program modules 42 may be configured to, e.g., scan data from several project artifacts, including but not limited to: Gant charts, project charters, project plans, project stakeholder lists, work breakdown structure (WBS), etc.; extract the relevant data from the scanned information including, e.g., tasks for the day, resources related to the tasks, users assigned to the tasks, identification of the resources, etc.; and automatically execute a request to an IAM or other management system (which may be integrated and/or internal to the present invention) to allow access to the resources by the assigned users or groups for the duration of the task. The access will be dynamic, therefore if a given task is extended by a project manager by updating any of the project artifacts, for example, the permissions will automatically be adjusted (updated). Once the task is marked as completed on the project plan, the access to the user will be automatically rescinded, ensuring that method supports the PoLP.

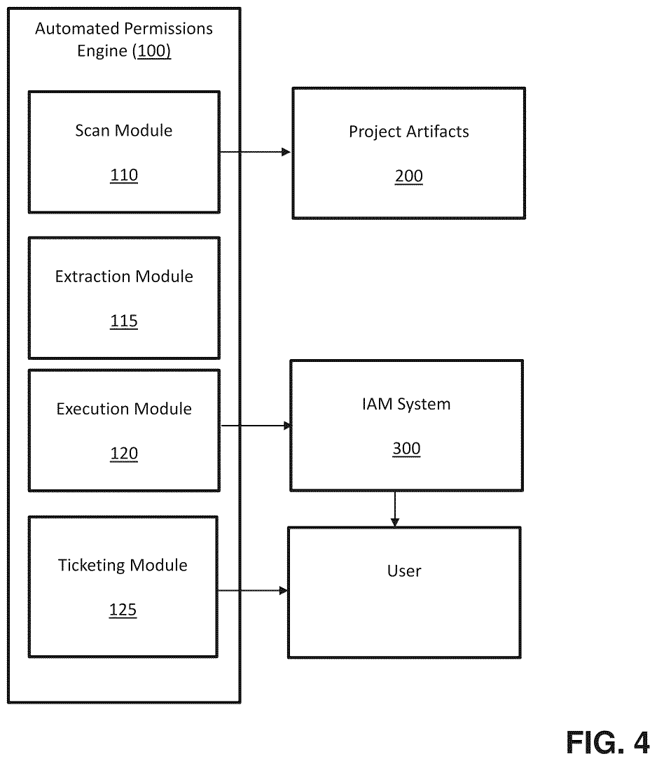

FIG. 4 shows a block diagram of an exemplary environment in accordance with aspects of the invention. In embodiments, the environment includes an automated permissions engine 100. The automated permissions engine 100 includes subcomponents or modules 110, 115, 120, 125 that can interface with outside components and users. For example, the modules (or engines) may include a scan module 110, an extraction module 115, an execution module 120 and a ticketing module 125. The outside components may be project artifacts components 200 and an IAM system 300. The IAM system 300 and the ticketing module 125 may communicate with a user assigned to particular tasks. The IAM system 300 and the ticketing module 125 may also be internal to the automated permissions engine 100.

In embodiments, the modules 110, 115, 120, 125 may comprise one or more program modules such as program modules 42 described with respect to FIG. 1. The automated permissions engine 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the scan module 110 may obtain information from one or more artifacts components 200. For example, the scan module 110 is configured to scan all the activities provided in Gant charts, project charters, project plans, project stakeholder lists, work breakdown structure (WBS), etc. The scan module 110 may scan the relevant activities at predetermined time periods, depending on the granularity and security required by an administrator or security team of an organization. These time periods may be once a day, may span multiple days or other predetermined time periods or suitable portions thereof, prior to working hours. For example, the scan module 110 may scan for the activities at 12:00 AM as one example.

As is known in the art, a Gant chart is a project management tool that helps visualize a project's timeline and progress over time. Also, as known in the art, a project charter is a formal document that is a roadmap to begin a project and outlining the scope, objectives, and stakeholders of the project. In addition, as known in the art, a project stakeholder list is a document that identifies and categorizes the people or groups involved in a project, and their roles in the project, acting as a project communications plan. Further, a work breakdown structure (WBS) is a project management tool that organizes a project into smaller, more manageable parts.

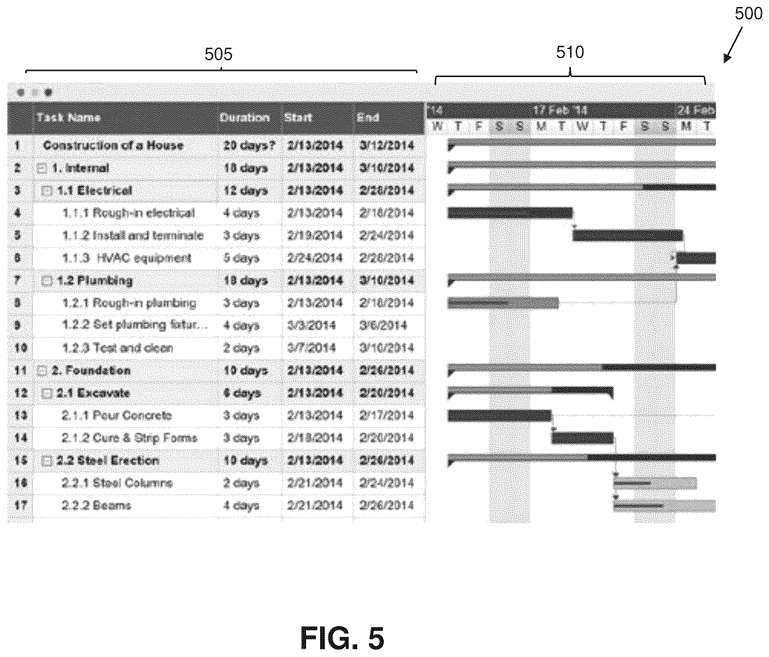

An exemplary Gant chart is shown in FIG. 5. The Gant chart includes a horizontal bar chart 500 that typically has a list of tasks 505 and a timeline with bars 510. The length of each bar shows the duration of a task, with the start and end dates visible. The tasks 505 may include the particular task, itself, the duration of the task, and start and end dates of each of the tasks.

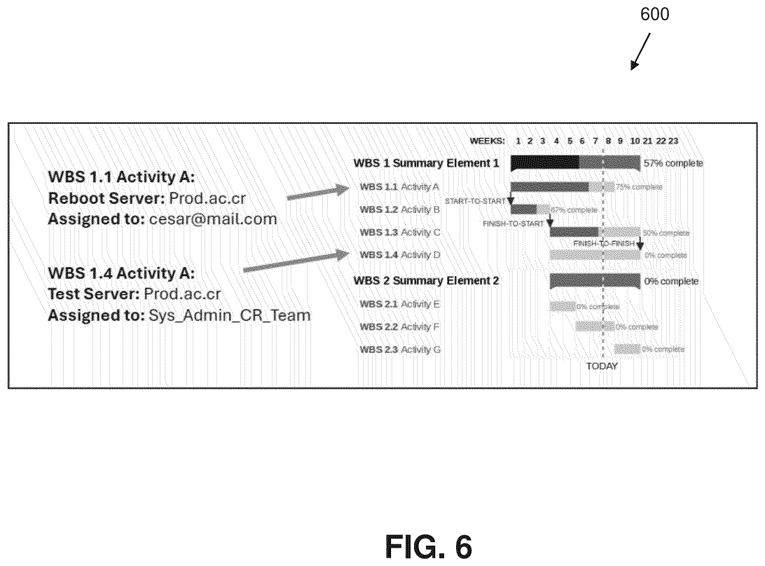

The extraction module 115 extracts the relevant information including, for example, tasks for the day, identification of resources related to the tasks and users assigned to the task from the project artifacts. This is shown representatively in FIG. 6. For example, as shown in FIG. 6, the extraction module 115 may extract activities (e.g., WBS 1.1 Activity A and WBS 1.4 Activity A), including which server is to be accessed, e.g., prod.ac,cr, and the user which is to access the server (although other information is also contemplated herein). In embodiments, the extraction module 115 may extract an email address of the user requiring access.

The execution module 120 automatically executes a request to the IAM or other-type of management system 300 to allow access to the resources by the assigned users or groups for the duration of the task. For example, in embodiments, execution module 120 may send instructions to the IAM or other-type of management system 300 to send permissions to the user, which allows access to the resources for a predetermined period of time. The request would include, for example, identification information of the resource that the user needs access to, and the contact information of the user.

In embodiments, the execution module 120 may connect to the IAM or other-type of management system 300 system using an API as is known in the art. In further embodiments, the IAM or other-type of management system may be integrated directly with the automated permissions engine 100. In other words, the automated permissions engine 100 may include the functionality of the IAM or other-type of management system. In the latter case or other implementations using the ticketing module 125, for example, the automated permissions engine 100 may directly communicate with the user to providing the required permissions. For example, the ticketing module 125 may provide a ticket to the user 300 on a daily basis or other suitable time periods as described herein, which includes the permissions, hence allowing the user access to the resources.

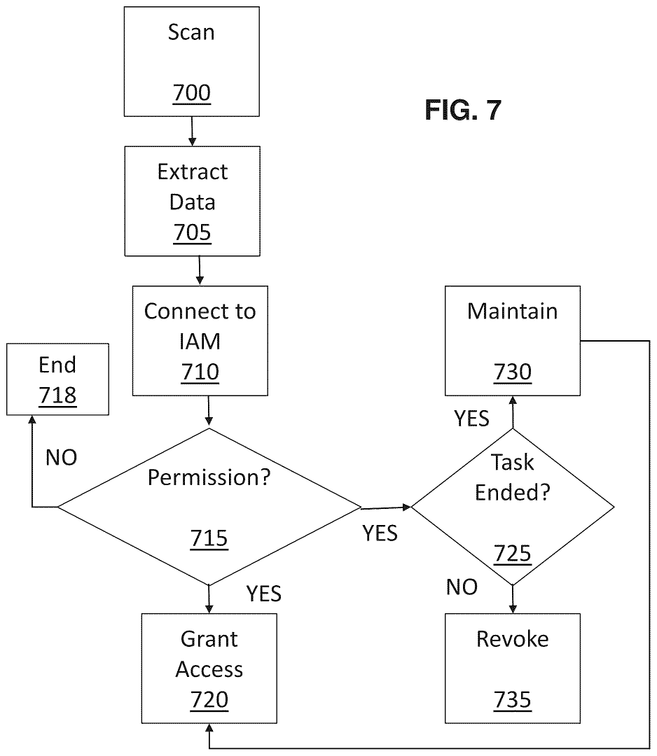

FIG. 7 shows a flowchart of an exemplary method in accordance with aspects of the present invention. Steps of the method may be carried out in the environment of FIG. 4 and are described with reference to elements depicted in FIG. 4.

At step 700, the system scans information from the one or more artifacts components, e.g., Gant charts, project charters, project plans, project stakeholder lists, work breakdown structure (WBS), etc. This information includes, for example, relevant activities at predetermined time periods and the user that is responsible for completing such relevant activities.

At step 705, the system will extract information from the scanned data including, for example, tasks for the day, identification of resources related to the tasks and users assigned to the task. The information related to the resources may be the identification of a server or other infrastructure, application or other document. The user information may include identification information and/or email addresses.

At step 710, the system connects to the IAM system via appropriate APIs. The system will provide the relevant extracted information to the IAM system including, for example, the specific tasks that need to be done, the user that is assigned to the tasks, identification information associated with resources and the specific task and, for example, an email address of the user that is assigned to the task.

At step 715, the system will check user permissions over the resources. If the user is not to be granted permissions, the system ends the process at step 718. If the user should be granted permissions, at step 720, the permissions are granted. If the user already has permissions, at step 725, the system will determine whether the task is already completed. If the task is not completed, at step 730, the system will maintain the permissions. If the task is completed, any permissions for the user assigned to the task will be revoked at step 735. Granted permissions can be provided to the user via a ticketing system (e.g., email).

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
scanning, by a computing device, one or more sources on a predetermined schedule to obtain project information;
extracting, by the computing device, project data from the project information, the project data including at least a user assigned to a task and a resource required to complete the task;
determining, by the computing device, that the user has permission to access the resource associated with the task; and
providing, by the computing device, the permission to the user to access the resource for a predetermined time period such that the user can gain access to the resource for the predetermined time period to work on the task.

2. The method of claim 1, wherein the one or more sources comprise project artifacts.

3. The method of claim 2, wherein the project artifacts comprise at least one Gant chart, project charter, project plan, project stakeholder list, or work breakdown structure.

4. The method of claim 1, wherein the predetermined schedule is a daily basis.

5. The method of claim 4, wherein the permission is provided to the user on the daily basis using a ticketing system.

6. The method of claim 4, wherein the permission is valid for a predetermined period which does not exceed the predetermined schedule associated with the scanning.

7. The method of claim 1, wherein the extracted information includes identification of a location of the resource and information to contact the user assigned to the task to be completed.

8. The method of claim 7, wherein the resource is at least one of a computing infrastructure, a software application or a document.

9. The method of claim 1, further comprising determining that the task has been completed based on an update scan of the project information.

10. The method of claim 9, further comprising revoking the permissions upon completion of the task.

11. The method of claim 1, wherein the computing device includes software provided as a service in a cloud environment.

12. A computer program product comprising one or more computer readable storage media having program instructions collectively stored on the one or more computer readable storage media, the program instructions executable to:
scan one or more project artifacts on a predetermined schedule to obtain project information;
extract the project information to obtain identification information of a resource and contact information of a user;
determine the user has permission to access the resource to complete a task that is scanned from the one or more project artifacts; and
provide the user with the permission to access the resource using the contact information and including the identification information of the resource.

13. The computer program product of claim 12, wherein the permission to access the resource is provided to a management system with instructions to send the permission to the user.

14. The computer program product of claim 12, wherein the permission is provided for a predetermined time period, not exceeding an amount of time between scheduled scans.

15. The computer program product of claim 12, wherein the one or more project artifacts comprise at least one Gant chart, project charter, project plan, project stakeholder list, or work breakdown structure.

16. The computer program product of claim 12, wherein the resource is at least one of a computing infrastructure, a software application or a document.

17. The computer program product of claim 12, wherein the one or more project artifacts are updated with updated project information as the user completes at least a portion of a task associated with the project information, and the scanning is performed on the updated project information.

18. The computer program product of claim 17, further comprising determining that the task assigned to the user has been completed and is provided at the updated project information.

19. The computer program product of claim 18, further comprising revoking the permission upon completion of the task.

20. A system comprising:
a processor, a computer readable memory, one or more computer readable storage media, and program instructions collectively stored on the one or more computer readable storage media, the program instructions executable to:
scan project information from one or more sources based on a predetermined schedule;
extract from the project information user information of a user assigned to a task and a resource location of a resource required to complete the task;
determine that the user assigned to the task should have permission to access the resource; and
provide instructions to a management system to send a permission to the user to access the resource.
